(19) United States
(12) Patent Application Publication
(10) Pub. No.: US 2026/0360653 A1
(43) Pub. Date: Nov. 12, 2026

(54) HOLLOW CATHODES WITH PRESSURE ENHANCING SKIRTS

(71) Applicant: The Government of the United States of America, as represented by the Secretary of the Navy, Arlington, VA (US)

(72) Inventors: Marcel P. Georgin, Washington, DC (US); Michael S. McDonald, Springfield, VA (US); John Foster, Ann Arbor, MI (US)

(73) Assignee: The Government of the United States of America, as represented by the Secretary of the Navy, Arlington, VA (US)

(21) Appl. No.: 19/199,831

(22) Filed: May 6, 2025

(51) Int. Cl. H01J 1/02; H01J 1/13; H01J 3/02

(52) U.S. Cl. CPC H01J 1/025; H01J 3/025; H01J 1/13

(57) ABSTRACT

A cathode system and method of supplying electrons is provided. In implementations, the cathode system includes a cathode tube including a gas inlet and a gas outlet, the cathode tube configured to generate plasma therein; and a cathode skirt connected to the cathode tube adjacent the gas outlet, the cathode skirt defining a channel between a plasma inlet and a plasma outlet through which plasma from the cathode tube is channeled. The cathode system may be a thermionic system or a radio frequency (RF) system.

### FEDERALLY SPONSORED RESEARCH AND DEVELOPMENT

The United States Government has ownership rights in this invention. Licensing inquiries may be directed to Office of Technology Transfer, US Naval Research Laboratory, Code 1004, Washington, D.C. 20375, USA; +1.202.767.7230; nrltechtran@us.navy.mil, referencing Navy Case No. 211335-US1.

### BACKGROUND OF THE INVENTION

Aspects of the present invention relate generally to electron generation and, more particularly, to electron generating cathodes with pressure enhancing skirts.

State of the art low-temperature electron sources for plasma propulsion come in the form of either thermionic cathodes or radio frequency (RF) plasma cathodes (often inductively coupled or electron cyclotron resonance). Both have a variety of applications, one of which is the supply of neutralizing current to plasma propulsion systems such as a Hall-effect thrusters (HETs) (also referred to as a Hall thruster or Hall-current thruster), and ion thrusters. While these sources function via different governing physical principles, there are many similarities. These cathodes are typically tubular in structure. A propellant gas (e.g., a noble gas for thermionic cathodes or molecular gases for RF cathodes) is flowed through the device, typically with a constricting orifice to control the pressure profile within. Either direct current (DC) or RF power is applied (depending on cathode type) to generate a high-density plasma within the device. The electrons are then extracted through an orifice where they become available to the thruster system. Conversely ions are collected at an electrically conducting surface inside the device.

Controlling the neutral flow environment in the downstream plume region for both types of cathode sources is critical to optimizing their performance. Often, raising the gas pressure in this region is useful to delay the onset of plasma instabilities or to generate a secondary plasma from the extracted electron beam. Previous pressure control schemes have been used, primarily in thermionic cathodes, including external gas injection, and the use of multiple orifices. These methods provide the benefit of an increased neutral pressure downstream of the orifice; however, these methods have some undesirable costs. Neutral gas injection requires additional propellant, which comes at a premium for space propulsion applications. Although the multiple orifice configuration is a passive method, it introduces a new failure mode where erosion of the keeper orifice over time may break off in relatively large pieces that lead to electrical shorts in the system. Accordingly, there remains a need for improved cathodes for providing electron sources for plasma propulsion.

### SUMMARY OF THE INVENTION

In a first aspect of the invention, there is a cathode system including: a cathode tube including a gas inlet and a gas outlet, the cathode tube configured to generate plasma therein; and a cathode skirt connected to the cathode tube adjacent the gas outlet. The cathode skirt defines a channel between a plasma inlet and a plasma outlet through which plasma from the cathode tube is channeled. The cathode tube and cathode skirt may be cylindrical. Alternatively, the cathode skirt may have a width at the plasma inlet that is smaller than a width at the plasma outlet.

The cathode system may be a thermionic cathode system including a heater configured to heat gas within the cathode tube. In implementations, an outer keeper electrode surrounds the cathode tube, and includes an exit through which plasma from the cathode tube is channeled into the plasma inlet of the cathode skirt. In embodiments, a cathode insert is located within the cathode tube adjacent the gas outlet and defines a plasma generating area.

In some embodiments, the cathode system is a radio frequency (RF) cathode system, which includes an RF antenna adjacent the cathode tube. In embodiments, the system also includes an anode opposite the plasma outlet. A power controller may be configured to control power supplied to the cathode tube and the anode. In some embodiments, the cathode skirt includes a first electrically conductive portion adjacent the plasma inlet and a second electrically insulated portion adjacent the plasma outlet.

In another aspect of the invention, there is a method of generating electrodes including: supplying gas into a cathode tube via a gas inlet of the cathode tube; generating plasma from the gas via power applied to the cathode tube; channeling the plasma through a gas outlet of the cathode tube and into a cathode skirt connected to the cathode tube, the cathode skirt defining a channel between a plasma inlet and a plasma outlet through which plasma from the cathode tube is channeled; and establishing a flow of ions and gas through the cathode tube and cathode skirt to the plasma outlet of the cathode skirt. The cathode skirt may include a first electrically conductive portion adjacent the plasma inlet and a second electrically insulated portion adjacent the plasma outlet. In implementation, the cathode skirt has a width at the plasma inlet that is smaller than a width at the plasma outlet. The cathode may be a thermionic cathode or an RF cathode. The method may further include applying, by an RF antenna adjacent the cathode tube, radio frequency power to the gas in the cathode tube, thereby generating the plasma within the cathode tube. The method may also include applying electricity to the cathode tube and to an anode spaced from the cathode tube, thereby establishing the flow of ions and gas through the cathode tube and cathode skirt to the plasma outlet.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 is a cross-sectional illustration of a prior art hollow cathode for a thermionic cathode system, and a pressure profile associated with the hollow cathode.

FIG. 2 is a cross-sectional illustration of a hollow cathode for a thermionic cathode system, and a pressure profile associated with the hollow cathode, in accordance with embodiments of the invention.

FIG. 3 depicts a thermionic cathode electron generating system in accordance with embodiments of the invention.

FIG. 4 illustrates an exemplary use scenario utilizing an electron generating system in a spacecraft application in accordance with embodiments of the invention.

FIG. 5 shows a graph of gas pressure (Torr) with respect to the axial distance from the cathode orifice or inlet (z) in millimeters (mm), for a pressure tube with a length of 50 mm, versus a free expansion case.

FIG. 6 depicts a radio frequency (RF) cathode electron generating system in accordance with aspects of the present invention.

FIG. 7 depicts a density ratio n/no as a function of distance (z) for a hemispherical expansion case and a pressure tube case in accordance with embodiments of the invention.

### DETAILED DESCRIPTION

Aspects of the present invention relate generally to electron generation and, more particularly, to electron generating cathodes with pressure enhancing skirts. Implementations of the invention provide a thermionic or radio frequency (RF) cathode for generating electrons, wherein a cathode skirt is attached to an outlet of a cathode to increase gas pressure at the outlet.

Embodiments of the invention provide a cathode system designed to slow or trap neutral gas particles that escape from a low-temperature plasma electron source (cathode device) to increase the neutral gas pressure near the cathode device. This is accomplished by extending the cathode device with additional structure in a plume region external of the body of the cathode device, where the additional structure is in the form of a pressure enhancing cathode skirt. Advantageously, thermionic cathode systems of the present invention include a cathode skirt that increases the neutral pressure outside of the cathode's outlet orifice to dampen-out instabilities that hurt cathode performance. Similarly, RF cathode systems of the present invention include a cathode skirt that increases pressure outside of the cathode's outlet orifice to enable greater ionization of the downstream gas, which improves cathode performance.

In embodiments, the cathode system generates a lower resistance path for current to flow through the plasma when compared to previous cathode devices. In some implementations, the pressure enhancing skirt is biased for the purpose of collecting ions, which can improve the current capacity of the cathode device as an electron source.

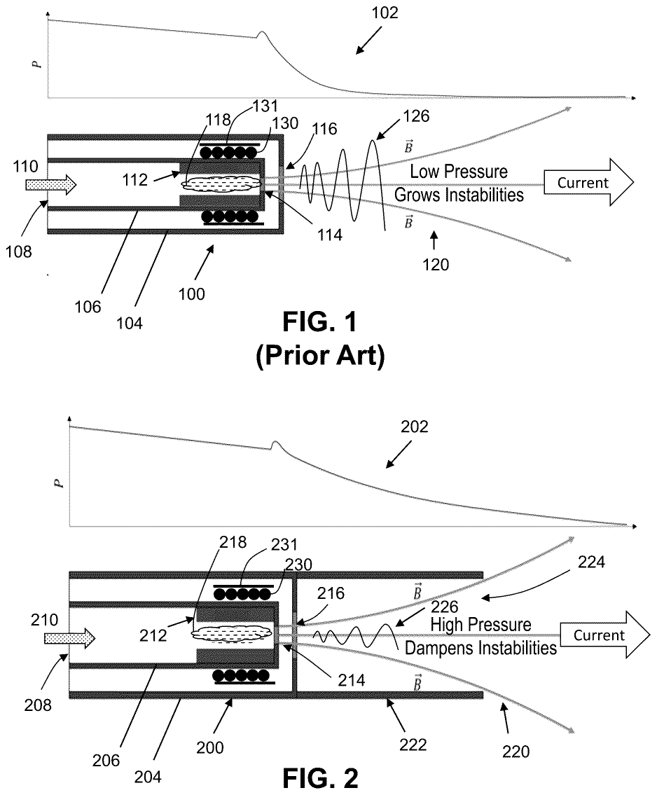

FIG. 1 is a cross-sectional illustration of a prior art hollow cathode 100 for a thermionic cathode system, and a pressure profile 102 associated with the hollow cathode 100. The hollow cathode 100 includes an outer keeper electrode 104 housing a cathode tube 106. The cathode tube 106 includes an opening 108 at a first end for receiving a gas (represented at 110), a cathode insert 112 adjacent an opposing second end of the cathode tube 106 defining a plasma generating portion, a heater 130 adjacent the cathode insert 112, a heat shield 131 between the heater 130 and the keeper electrode 104, and an opening 114 at the second end. In use, plasma (represented at 118) is formed within the plasma generating portion, exits through the opening 114 in the cathode tube 106, and then exits out an opening (orifice) 116 in the outer keeper electrode 104, as depicted at 120. The term plasma as used herein refers to an ionized gas consisting of positive ions and free electrons. As demonstrated by the pressure profile 102, the neutral gas density (pressure) changes as it flows through and exits the hollow cathode 100, and has a sharp drop off in pressure shortly after leaving the outer keeper electrode 104. Plasma instabilities are represented at 126. In general, the low pressure outside the hollow cathode 100 results in the plasma instabilities 126.

In general, it is desirable for efficient cathode operation to: 1) generate as much plasma as possible, 2) minimize the extraction voltage, and 3) deliver the current stably. Advantageously, embodiments of the invention achieve these goals by increasing the downstream pressure of a cathode device using a pressure enhancing cathode skirt.

FIG. 2 is a cross-sectional illustration of a first hollow cathode 200 for a thermionic cathode system, and a pressure profile 202 associated with the hollow cathode, in accordance with embodiments of the invention. The hollow cathode 200 includes an outer keeper electrode 204 housing a cathode tube 206. The cathode tube 206 includes an opening 208 at a first end for receiving a gas (represented at 210), a cathode insert 212 adjacent an opposing second end defining a plasma generating portion, a heater 230 adjacent the cathode insert 212, a heat shield 231 between the heater 230 and the keeper electrode 204, and an opening 214 at the second end. In implementations, plasma (represented at 218) is formed within the plasma generating portion, and the plasma and gas exit first through the opening 114 in the cathode tube 206, and then out an opening (orifice) 216 in the outer keeper electrode 204. A cathode skirt 222 extends beyond the opening 216 in the outer keeper electrode 204, and defines a housing through which the plasma and gas (represented at 220) are channeled before exiting through an opening 224 in the cathode skirt 222. The cathode skirt 222 may be designed to retrofit existing cathodes.

As demonstrated by the pressure profile 202, the neutral gas density (pressure) changes as it flows through and exits the hollow cathode 200. Unlike the pressure profile 102 of the prior art cathode in FIG. 1, the neutral gas density (pressure) does not drop abruptly after discharging through the opening in the keeper electrode, but instead tapers off more gradually due to the presence of the cathode skirt 222. Plasma instabilities are represented at 226. In general, the relatively higher pressure outside the hollow cathode 200 caused by the cathode skirt 222 (as compared with the pressure outside of the hollow cathode 100), dampens the plasma instabilities 226 outside of the cathode 200.

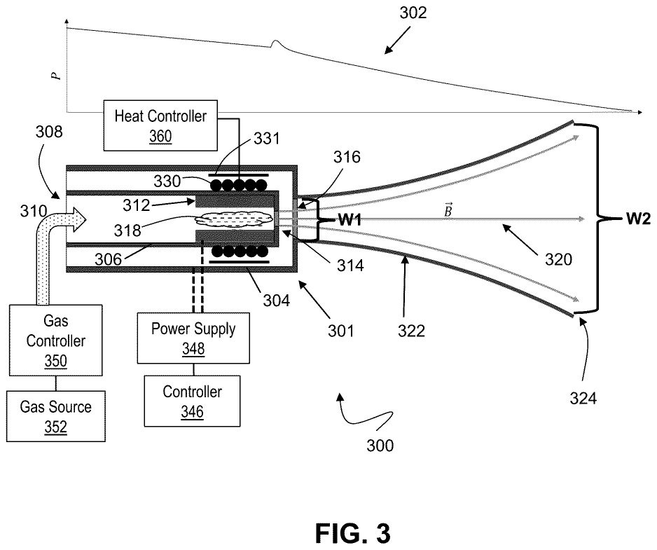

FIG. 3 depicts a thermionic cathode electron generating system 300 in accordance with embodiments of the invention. The system of FIG. 3 includes a hollow cathode 301 having an outer keeper electrode 304 housing a cathode tube 306. The cathode tube 306 includes an opening 308 at a first end for receiving a gas (represented at 310), a cathode insert 312 adjacent an opposing second end defining a plasma generating portion, a heater 330 adjacent the cathode insert 312, a heat shield 331 between the heater 330 and the keeper electrode 304, and an opening 314 at the second end. In implementations, plasma (represented at 318) is formed within the plasma generating portion, and the plasma 318 and gas exit first through the opening 314 in the cathode tube 306, and then out an opening (orifice) 316 in the outer keeper electrode 304. A cathode skirt 322 extends beyond the opening 316 in the outer keeper electrode 304, and defines a housing through which the plasma and gas (represented at 320) are channeled before exiting through an opening 324 in the cathode skirt 322. Unlike the cylindrical shape of the cathode skirt 222, the cathode skirt 322 has a trumpet shape having a first width W1 adjacent the cathode outlet 316, and a second width W2 defining the outlet 324 of the cathode skirt 322, wherein W1 is less than W2. In this implementation, the shape of the cathode skirt 322 is configured to conforming to the magnetic field structure generated by an electric compulsion system, such as a Hall-effect thruster (HET). While the system of FIG. 3 is shown with the cathode skirt 322, it should be understood that cathode skirt 222 could alternatively be utilized in the system of FIG. 3. Cathode skirts of the present invention may be made from electrically conductive materials, electrically non-conductive materials, or a combination of both.

As demonstrated by the pressure profile 302, the neutral gas density (pressure) changes as it flows through and exits the hollow cathode 300. Unlike the pressure profile 102 of the prior art cathode in FIG. 1, the neutral gas density (pressure) does not drop abruptly after discharging through the opening in the keeper electrode, but instead tapers off more gradually due to the cathode skirt 322. As with the cathode skirt 222 of FIG. 2, the cathode skirt 322 of FIG. 3 results in a relatively higher pressure outside the hollow cathode 300 (as compared with the pressure outside of the hollow cathode 100), which dampens plasma instabilities.

With continued reference to FIG. 3, in embodiments, a power controller 346 in communication with a direct current (DC) power source 348 selectively controls the application of electrical current to the cathode insert 312 and the keeper electrode 304 to establish an electric field within the cathode 301. In use, a gas controller 350 initiates the feeding of a gas from a gas source 352 to the inside of the cathode tube 306. In implementations, the gas flows via convection into the cathode tube 306. A heat controller 360 initiates the heater 330 to heat the cathode insert 312 within the cathode tube 306. Heating the cathode insert 312 causes electrons within the metal to gain enough energy to escape the surface and be emitted as a stream (thermionic emission), allowing the electrons to be drawn away by the electric field generated by the cathode insert 312 and the keeper electrode 304. The electrons collide with and ionize neutral gas particles adjacent the cathode insert 312, thereby creating a cloud of charged particles that constitutes the plasma 318. Electrons flow through the electron exiting end 314 of the cathode tube 306 and the electron stream outlet 316 of the keeper electrode 304, and toward the electron exiting end 324 of the cathode skirt 322.

While the cathode skirts 222 and 322 of FIGS. 2 and 3 are shown in a thermionic cathode system, it should be understood that the cathode skirts 222, 322 may be utilized in a RF cathode system in accordance with implementations of the invention. Moreover, the shape of the cathode skirts is not intended to be limited to the examples discussed herein, and other shapes of cathode skirts may be utilized in accordance with implementations of the invention.

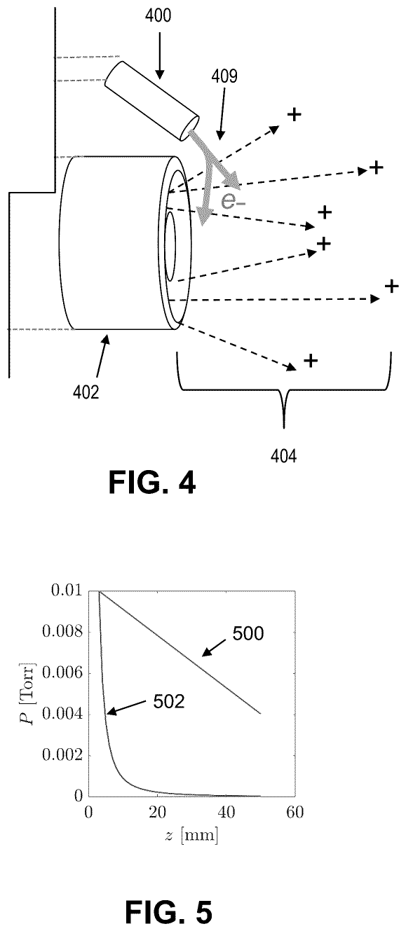

FIG. 4 illustrates an exemplary use scenario utilizing an electron generating system 400 in a spacecraft application in accordance with embodiments of the invention. Advantageously, implementations of the invention provide an improved electron generating system 400 that outputs a more efficient source of electrons for a HET indicated at 402. In general, the HET 402 uses a magnetic field to limit electrons' axial motion and uses the electrons to ionize a propellant to create an ionized plasma plume, accelerates the ions to produce thrust as indicated at 404, and neutralizes the ions in the plasma plume. In accordance with embodiments of the invention, the electron generating system 400 outputs an electron beam indicated at 409 to neutralize the ions in the plasma plume. In implementations, the electron generating system 400 comprises cathodes of the present invention (e.g., the cathodes of FIG. 2, 3 or 6).

The following sections describe how a pressure enhancing skirt according to embodiments of the invention lead to improvements to both thermionic cathodes and RF cathodes.

### Basic Equations

Initially, treatment of a region downstream of a cathode orifice (e.g., 116 of FIG. 1) in a free molecular flow regime is addressed, where particle collisions are few. If the standard cathode design is approximated as a hemispherical source of gas, then the neutral gas density (pressure P(r)) in the downstream region evolves the following equation EQ(1), wherein r₀ represents the radius of a cathode orifice, r is the radial distance from the orifice, and P₀ is a pressure at the orifice:

$$P ( r ) ≃ {P}_{0} ( \frac{r {0}^{2}}{r} ) . \qquad EQ ( 1 )$$

The r⁻² dependence on the pressure results in a rapid decrease in pressure near the gas source. However, when introducing a pressure enhancing cathode skirt in accordance with embodiments of the invention, the cathode tube conductance must be accounted for. In this case, the gas pressure gradient is represented by the following equation EQ(2), wherein Q is the volumetric flow rate, C is the gas conductance, l is the length of the cathode tube, and z is the axial distance from the orifice:

$$P = {P}_{0} - \frac{Q}{C} ( \frac{z}{l} ) . \qquad EQ ( 2 )$$

For a cathode tube in the free molecular regime, the gas conductance C is given by the following equation EQ(3), wherein cₛ is the sound of speed, and d³ is diameter of the tube:

$$C = \frac{{c}_{s} π}{12} ( \frac{{d}^{3}}{l} ) . \qquad EQ ( 3 )$$

FIG. 5 shows a graph of gas pressure (Torr) with respect to the axial distance from the cathode orifice or inlet (z) in millimeters (mm), for a cathode with a cathode skirt (pressure tube) 500 with a length of 50 mm, versus a free expansion case 502 (i.e., no cathode skirt). Spherical expansion of the gas from a point source is plotted at 502, while gas pressure along a length of a cathode tube having a cathode skirt in accordance with embodiments of the invention is plotted at 500. FIG. 5 illustrates how the pressure downstream of a cathode orifice can be significantly elevated by introducing a cathode skirt (pressure tube structure) to the cathode. Air having a temperature of 20 degrees Celsius (°C) was utilized with a volumetric flow rate of 20 standard cubic centimeters per minute (secm) in order to show the plotted trends. Note the rapid decrease in pressure for the free expansion case (502) in comparison to the pressure enhancing skirt case (500), which decreases linearly. The increase in gas pressure demonstrated at 500 has important implications for cathode performance, as discussed in more detail below.

### I. Thermionic Cathodes

For thermionic cathodes, the neutral gas density (pressure) is critical in all regions of the device. Internally, the pressure profile in part dictates the emission and evaporation profiles along the length of the emitter (cathode). Outside the cathode device, the neutral pressure is important for determining the resistivity of the plasma in this region, which through Ohm's law in part dictates the voltage efficiency of the cathode device, as well as the overall stability of the current delivered by the device.

The connection between these global parameters (efficiency and stability) and local neutral gas density is in large part due to the critical link between neutral pressure and damping of electrostatic drift waves in the cathode system, known as ion acoustic turbulence (IAT). Several experimental and numerical studies have shown that these waves can effectively enhance the plasma resistivity to over an order of magnitude beyond the classical limit. The resistivity of the electrons is represented by the following equation EQ(4), wherein mₑ is the electron mass, vₑ is the electron collision frequency, q is the unit charge, and nₑ is the electron density:

$${P}_{e} = \frac{{m}_{e} {v}_{e}}{{qn}_{e}} . \qquad EQ ( 4 )$$

The collision frequency is dominated by the effect of the waves and typically evolves according to the following formula EQ(5), wherein mᵢ is the ion mass, ω₀ is the mean frequency of the waves, W is the energy density of the electrostatic waves, ν_{IAT} is effective electron collision frequency due to the waves, nₑ is the electron density, and Tₑ is the electron temperature:

$${V}_{e} ≃ {v}_{IAT} = \sqrt{\frac{π}{2} \frac{{m}_{i}}{{m}_{e}}} {ω}_{0} \frac{W}{{n}_{e} {T}_{e}} . \qquad EQ ( 5 )$$

The wave energy density in the plasma can be approximated using the linear theory for ion acoustic waves and the conservation of wave energy, using the following formula EQ(6), wherein \vec{v_{y}} represents the group velocity of the waves,

$${M}_{e} ≡ \frac{{u}_{e}}{{v}_{e}}$$

is the electron Mach number, Tₑ and Tᵢ are the electron and ion temperatures, and vᵢₙ is the ion-neutron collision frequency:

$$\frac{\partial W}{\partial t} + ∇ \cdot ( \vec{{v}_{g}} W ) = {ω}_{0} W \sqrt{\frac{π}{2}} ( {M}_{e} - {( \frac{{T}_{e}}{{T}_{i}} )}^{\frac{3}{2}} {e}^{- \frac{{T}_{e}}{2 {T}_{i}}} - \frac{{v}_{in}}{{ω}_{o}} ) . \qquad EQ ( 6 )$$

Physically, the Mach number allows for the growth of the energy held in instabilities while the ratio of the temperatures and the collision frequency dampen the waves. To minimize the effect of the ion acoustic waves on both resistance and stability of the plasma, their energy density must be reduced. Experimentally, it is difficult to control the Mach number or the temperatures in the plasma. However, it is fairly easy to influence the ion-neutral collision frequency with either flow rate or design. Since vᵢₙ∝nn∝P, we expect based on the example in FIG. 5 that including a pressure enhancing skirt in the plume region of a cathode will increase the damping of the turbulence, which in turn reduces the resistivity and increases the stability of the plasma.

In the case of center-mounted thermionic cathodes in Hall thrusters, the primary design constraint is the shape of the magnetic field. If a cathode skirt in accordance with embodiments of the invention intersects with the magnetic field lines emanating from the edges of the cathode orifice, then significant erosion of the skirt will occur. For externally mounted devices, the primary constraint is the distance from the cathode to the edge of the thruster ion beam.

### II. RF Cathodes

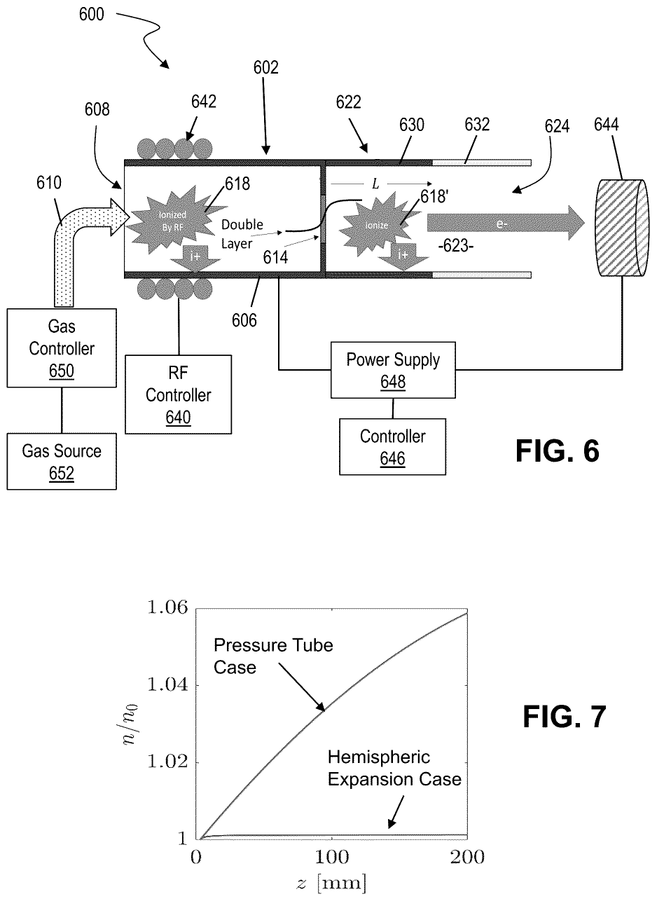

FIG. 6 depicts an RF cathode electron generating system 600 in accordance with aspects of the present invention. Elements of the electron generating system 600 may be modular. In implementations, an electron beam generating device 602 is in the form of the hollow cathode including a cathode tube 606 having an opening or orifice 608 at a first end for receiving a gas (represented at 610), and an opening/orifice 614 at the second end. In embodiments, the gas 610 comprises argon (Ar), xenon (Xe), or another noble gas. In implementations, plasma (represented at 618) is formed within the plasma generating portion of the cathode tube 606, and the plasma 618 and gas exit first through the opening 614 in the cathode tube 606, and then out an opening 624 in a cathode skirt 622 extending from the cathode tube 606. In embodiments, the cathode skirt 622 increases gas pressure in the same manner as the cathode skirt 222 of FIG. 2.

In implementations, the cathode skirt 622 defines an area 623 through which the plasma 618 and gas 610 are channeled before exiting through an opening 624 in the cathode skirt 622. In some embodiments, the cathode skirt 622 comprises a conductive portion 630, which increases ion collection to generate additional plasma at 618′, as well as an insulating portion 632 to enhance the pressure. In use, ions are collected on the surface (as indicated at i+) of the cathode tube 606, and electrons (e−) are accelerated through double layer to the cathode skirt region 622. Ionization occurs over ionization length L where ions are collected at the conducting portion 630 of the cathode skirt 622 (as indicated at i+). In embodiments, the electrons are then extracted to a stream anode 644 spaced at a distance from the electron exiting end 624 of the cathode skirt 622. In a ground testing scenario, the anode 644 simulates a thruster pulling electrons from the cathode source. In a use scenario, the anode 644 represents an anode of a thruster. The conductive portion 630 may be made from a refractory metal, for example tungsten, molybdenum, or tantalum. The insulating portion 632 may be made from a ceramic, for example alumina or boron nitride.

With continued reference to FIG. 6, an RF controller 640 selectively controls the application of an RF signal to the RF antenna 642, which causes the RF antenna 642 to generate an RF field (RF power). In implementations, the RF antenna 642 is adjacent the open end 608 of the cathode tube 606 (e.g., extends around an exterior of the cathode tube 606), such that the RF field generated by the RF antenna 642 interacts with gas 610 within the cathode tube 606 to create the plasma indicated at 618. In implementations, a power controller 646 in communication with a direct current (DC) power source 648 selectively controls the application of electrical current to the anode 644 and cathode tube 606.

In accordance with an exemplary embodiment of the invention, in use, a gas controller 650 initiates the feeding of a gas from a gas source 652 to the inside of the cathode tube 602. In implementations, a neutral gas flows via convection into the cathode tube 602. As indicated above, the RF controller 640 applies an RF signal to the RF antenna 642, which generates an RF field (RF power) that interacts with gas 610 within the cathode tube 602 to form the plasma 618. In implementations, the controller 646 initiates the application of an electrical current to the anode 644 and cathode tube 604, which causes an electrical current through the plasma 618, wherein electrons (represented at e−) flow from the plasma 618 towards the anode 644 through the electron exiting end 614 of the cathode tube 602 and the electron stream outlet 624 of the cathode skirt 622.

Various gasses, gas controlling devices, and gas controlling steps may be utilized in conjunction with the electron generating system 600, and the invention is not intended to be limited to examples described herein. Moreover, in implementations, the cathode skirt 322 of FIG. 3 may be utilized in place of the cathode skirt 622, and may include a conductive portion adjacent the end of the cathode 602, which increases ion collection to generate additional plasma 618′, as well as an insulating portion defining the cathode skirt opening/exit 624.

For radio frequency (RF) cathodes, the current generation mechanism is fundamentally limited by the ability of the cathode to collect ion current. The ion current is given by the following equation EQ(7), where q is the unit charge, nᵢ is the ion density, cₛ is the Bohm speed, and A_{c} is the surface area of the ion collector:

Iᵢ=qnᵢcₛA_{c}. EQ(7):

The ion density of an RF cathode is typically controlled by the gas flow rate and applied RF power, and surface area is a relatively free design parameter. For an RF cathode device to operate in an efficient manner, the device must generate as much plasma as possible and have as great a surface area as possible to collect the ions. When operating RF cathode devices on molecular gases, the optimal internal gas pressure tends to be low. This is because when too many molecules are present, a significant amount of the RF power is deposited into inelastic collisions that do not yield additional plasma. However, when electrons are extracted to an anode, they are thought to be accelerated by a double layer that forms at the orifice. This generates an electron beam with large kinetic energy on the order of the discharge voltage (50 V-100 V) which can be leveraged to ionize a downstream gas.

Thus, in the RF cathode embodiment of FIG. 6, the pressure enhancing cathode skirt 622 can serve a dual purpose. The first is to increase the neutral gas density downstream, providing a dense target to enhance the plasma production rate downstream of the cathode orifice 614. This follows from the expression n∝nₙ∝P, wherein n is volumetric flow rate, nₙ is neutral gas density, Pis total pressure, and \dot{n} is proportional to nₙ, which is proportional to P. Second, if the pressure enhancing cathode skirt 622 is made from a conductive material, the ion collection area can be increased as represented by the following equation EQ(8), further raising the current capacity of the electron generating device:

(Aₜₒₜ=Ac+Aₛₖᵢᵣₜ), EQ(8):

wherein Aₜₒₜ is the total cathode area, Ac is internal cathode area, and Aₛₖᵢᵣₜ is the additional cathode area from the skirt.

The following equation EQ9 will now be discussed, wherein L represents the length scale over which we expect the plasma density to increase due to ionization in the plume (i.e., an ionization length) and Ue is the electron kinetic energy.

$$\frac{\partial ( n ) {u}_{e}}{\partial z} ≃ {nv}_{iz} ⇒ \frac{1 \partial n}{n \partial z} ≡ \frac{1}{L} = \frac{{v}_{iz}}{{u}_{e}} = \frac{{n}_{n} {σ}_{iz} {u}_{e}}{{u}_{e}} = {n}_{n} {σ}_{iz} ( {U}_{e} ) . \qquad EQ ( 9 )$$

In terms of discharge parameters, the neutral density scales with the downstream pressure and the ionization cross section will generally scale with the electron energy, which is related to the discharge voltage. Thus, we have the following equation EQ(10):

$$L ∝ \frac{1}{{PV}_{dc}} . \qquad EQ ( 10 )$$

This equation (EQ10) indicates that a greater pressure and discharge voltage will cause the plasma density to increase over a shorter length. As a sample calculation, consider a CO₂ discharge with a downstream pressure of 50 mTorr at 300 K and a discharge voltage of 100 V (typical of a molecular gas discharge). Then the length scale is approximately 1.8 cm. Thus, we expect that a cathode skirt length between 2 cm and 20 cm should yield an improved ionization rate. Note that this simple calculation considers a constant pressure within the cathode tube, which we know is changing as a function of position, as shown in FIG. 5. Using the pressure profiles from FIG. 5 and applying them to EQ9, we plot in the ratio of the densities in FIG. 7.

More specifically, FIG. 7 depicts a density ratio n/no as a function of distance (z) for a hemispherical expansion case and a pressure tube (cathode skirt) case. In this figure, we see that including a tube-shaped cathode skirt would increase the plasma density by 6% over 20 cm, while the standard hemispherical model of plasma expansion results in only 0.1% additional ionization. This qualitatively suggests that increasing the downstream pressure should lead to greater plume ionization.

To fully realize the enhancement to the current capacity of an RF cathode, the ions generated by downstream ionization must be collected. Including a conducting pressure tube, shorted to the cathode, could be used to collect these additional ions. However, this introduces a shorting path for the discharge if this additional electrode is too close to the anode. This will eliminate the double layer (an electrostatic potential structure that forms in the plasma at the orifice) that serves to accelerate the electrons to sufficient energies to achieve the enhanced ionization in the skirt region. Thus, one must take care when designing additional ion collection surfaces in this downstream region.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A cathode system comprising:
a cathode tube including a gas inlet and a gas outlet, the cathode tube configured to generate plasma therein; and
a cathode skirt connected to the cathode tube adjacent the gas outlet, the cathode skirt defining a channel between a plasma inlet and a plasma outlet through which plasma from the cathode tube is channeled.

2. The cathode system of claim 1, wherein the cathode tube is cylindrical.

3. The cathode system of claim 1, wherein the cathode skirt is cylindrical.

4. The cathode system of claim 1, wherein the cathode skirt has a width at the plasma inlet that is smaller than a width at the plasma outlet.

5. The cathode system of claim 1, wherein the cathode system is a thermionic cathode system.

6. The cathode system of claim 5, further comprising a heater configured to heat gas within the cathode tube.

7. The cathode system of claim 5, further comprising an outer keeper electrode surrounding the cathode tube, the outer keeper electrode including an exit through which plasma from the cathode tube is channeled into the plasma inlet of the cathode skirt.

8. The cathode system of claim 5, further comprising a cathode insert within the cathode tube adjacent the gas outlet, the cathode inserts defining a plasma generating area.

9. The cathode system of claim 1, wherein the cathode system is a radio frequency (RF) cathode system.

10. The cathode system of claim 9, further comprising a radio frequency antenna adjacent the cathode tube.

11. The cathode system of claim 9, further comprising an anode opposite the plasma outlet.

12. The cathode system of claim 11, further comprising a power controller configured to control power supplied to the cathode tube and the anode.

13. The cathode system of claim 1, wherein the cathode skirt comprises a first electrically conductive portion adjacent the plasma inlet and a second electrically insulated portion adjacent the plasma outlet.

14. A method of generating electrons comprising:
supplying gas into a cathode tube via a gas inlet of the cathode tube;
generating plasma from the gas via power applied to the cathode tube;
channeling the plasma through a gas outlet of the cathode tube and into a cathode skirt connected to the cathode tube, the cathode skirt defining a channel between a plasma inlet and a plasma outlet through which plasma from the cathode tube is channeled; and
establishing a flow of ions and gas through the cathode tube and cathode skirt to the plasma outlet of the cathode skirt.

15. The method of claim 14, wherein the cathode skirt comprises a first electrically conductive portion adjacent the plasma inlet and a second electrically insulated portion adjacent the plasma outlet.

16. The cathode system of claim 14, wherein the cathode skirt has a width at the plasma inlet that is smaller than a width at the plasma outlet.

17. The method of claim 14, wherein the cathode is a thermionic cathode.

18. The method of claim 14, wherein the cathode is a radio frequency (RF) cathode.

19. The method of claim 18, further comprising applying, by a radio frequency antenna adjacent the cathode tube, radio frequency power to the gas in the cathode tube, thereby generating the plasma within the cathode tube.

20. The method of claim 18, further comprising applying electricity to the cathode tube and to an anode spaced from the cathode tube, thereby establishing the flow of ions and gas through the cathode tube and cathode skirt to the plasma outlet.
